(19) United States
(12) Patent Application Publication
(10) Pub. No.: US 2012/0312439 A1
(43) Pub. Date: Dec. 13, 2012

(54) TIRE TREAD REINFORCED WITH SHORT ORIENTED AND CROSSED FIBERS

(75) Inventors: Alexis Bournat, Clermont-Ferrand (FR); Patrick Corsi, Thuret (FR)

(73) Assignees: Michelin Recherche et Technique S.A., Granges-Paccot (CH); Compagnie Generale Des Etablissements Michelin, Clermont-Ferrand (FR)

(21) Appl. No.: 13/514,555

(22) PCT Filed: Dec. 3, 2010
(86) PCT No.: PCT/EP2010/068881

§ 371 Date: Aug. 29, 2012

(30) Foreign Application Priority Data
Dec. 8, 2009 (FR) 09/58729

(51) Int. Cl. B60C 11/117; B32B 25/02; B32B 5/12

(52) U.S. Cl. 152/209.18; 428/113

(57) ABSTRACT

Tire tread provided with a tread surface designed to be in contact with a roadway, this tread comprising a sculpture formed by raised elements delimiting at least two grooves of generally circumferential orientation, this tread comprising a composite material constructed by the stacking of a plurality of layers of rubber, each layer comprising a plurality of short reinforcing fibers that are parallel with one another and oriented in a single direction, the short fibers being crossed from one layer of rubber to the adjacent layer]. Tire provided with such a tread.

The subject of the present invention is an improvement of the treads for tires designed to be fitted to heavy goods vehicles; it relates in particular to the sculpture of these treads.

This invention is notably, but not exclusively, intended to be used for tires with a radial carcass and intended for the steering axles of heavy goods vehicles. It may however also be used for non-steering axles of heavy goods vehicles and for off-road vehicles such as agricultural (forest) machines or for construction machines.

Such tires usually comprise a carcass reinforcement surmounted radially on the outside by a crown belt, itself covered with a tread. This tread is provided with a sculpture essentially formed of ribs of generally circumferential orientation delimited by grooves of the same orientation or of blocks delimited by circumferential grooves and transverse grooves or by a combination of blocks and ribs. Axially a tread is delimited by edge ribs.

### RELATED ART

In the case of tires intended for the regional sector (running on regional roads, short and medium distances) having a tread sculpture having ribs and grooves of circumferential orientation, it is possible to note a sensitivity to the tearing of the edges of the edge ribs depending on the conditions of running and of use. Such conditions are obtained notably during severe stresses such as for example when driving up or driving down kerbs during goods deliveries or during impacts against kerbs or obstacles or foreign bodies that are present on the roadway or on the ground. This sensitivity to tearing is partly dependent on the nature of the gum which forms the edge rib and it is often more pronounced when the gum used is a mixture of natural rubber with one or more synthetic rubbers that is beneficial for reduced wear of the tread.

In order to prevent the appearance of tears as indicated above and to limit the shearing induced by such stresses, various solutions have been proposed which usually aim to reduce the aspect ratio of the edge rib, that is to say the height/width ratio of this rib, by increasing the width of the said edge rib. Such a geometric modification has the drawback of having to redefine the whole sculpture of the tread.

The present invention proposes to solve the exposed technical problem by making it possible to prevent or at the very least retard and greatly limit the tears of gum of the edge ribs, or even the damage at the bottom of the recess of a groove of generally circumferential orientation, that can result from severe stress such as driving up or driving down a kerb or an impact against a kerb or other obstacles present on the roadway or the tread surface without modifying the geometry of the tread.

In order to solve the technical problem without modifying the sculpture of the tread, the invention proposes to increase the shear modulus of the elastomeric material that forms the tire tread by a factor at least equal to three by reinforcing the gum with short fibers oriented substantially at +/−45° relative to a radial direction of the tire casing and thus transforming it into a stratified composite material.

The addition of short fibers of various kinds with rubber compositions intended for tire treads is well known. U.S. Pat. No. 1,746,948 describes a tire tread with a crossed carcass comprising an elastomeric ply including long textile fibers wound around a rubber core, these long fibers being inclined relative to the surface of the tread and being flush with the said tread surface in order to form points of grip on the roadway and thus prevent or retard the skidding of the tire on wet or slippery roadway.

U.S. Pat. No. 3,057,389 describes a passenger-car tire tread or aircraft tire tread with a crossed carcass comprising grooves of generally longitudinal orientation and a continuous raised element in the circumferential direction, the gum forming the whole of the tread consisting of a stack of rubber plies reinforced with short textile fibers parallel with one another in order to increase the resistance of the tire to the centrifugal forces tending to destroy it at high speed. The short fibers oriented parallel with one another may be placed in the circumferential direction in a plane parallel to a plane tangential to the tread surface and in the direction OX (OX being the circumferential direction) or may be crossed in a plane parallel to a plane tangential to the tread surface and in the direction OY (OY being the direction of the rotation axis) or the short fibers oriented parallel with one another and placed in the circumferential direction in a plane parallel to a plane tangential to the tread surface and in the direction OX may be included between two plies of short crossed fibers in a plane parallel to a plane tangential to the tread surface and in the direction OY respectively placed on top of and underneath the ply comprising the short fibers that are oriented circumferentially.

Patent application WO 2008/027045-A1 describes a tread for a passenger-car tire and for a heavy goods vehicle tire comprising grooves of generally longitudinal orientation and a continuous raised element in the circumferential direction and teaches that the use for the gum forming the continuous circumferential ribs of plies or thin layers of rubber reinforced with short glass microfibers parallel with one another and oriented either circumferentially in the direction OX, or oriented in a plane YOZ (that is to say in a plane perpendicular to the tread surface of the tread containing a direction parallel to the direction of the rotation axis and a direction perpendicular to the rotation axis oriented according to the thickness of the raised element in the direction OZ), or oriented transversely in a direction OY, or oriented substantially at +45° or −45° in a plane XOZ, or oriented at 45° in a plane XOY, makes it possible to obtain a good compromise of properties, namely an increased rigidity without penalizing, or even improving, the hysteretic and stretching and wear-resistance properties.

The subject of the invention is a tire tread provided with a tread surface designed to be in contact with a roadway, this tread comprising a sculpture formed by raised elements separated from one another by grooves, this tread being formed by a gum consisting of thin layers of rubber stacked one against the other, each thin layer comprising short reinforcing fibers that are parallel with one another in the layer and oriented in one direction in the plane of the layer at one and the same angle. The tread is characterized in that the thin layers are stacked one against the other so that the short fibers are crossed from one layer to the next.

The short reinforcing fibers are thus alternately oriented symmetrically from one layer to the adjacent layer in the circumferential direction at an angle ranging in absolute value from 10° to 80° relative to a radial direction in the plane of the layer. According to an advantageous embodiment of the invention, the short fibers are oriented at an angle ranging in absolute value from 30° to 60° relative to a radial direction in the plane of the layer. According to one variant embodiment, the orientation of the short reinforcing fibers may vary in the crossing plane and not be symmetrical. Similarly, a variation in the crossing angle may also be made in the circumferential direction (in a direction tangential to the circumferential direction).

According to a preferred embodiment of the invention, the short reinforcing fibers are alternately oriented from one layer to the adjacent layer circumferentially at an angle substantially of +45° and of −45° over the whole width of the tread. “Substantially” equal to an angular value should be understood to mean an angle that may be different from this angular value by at most 3° in absolute value.

According to another embodiment of the invention, each thin layer reinforced by short fibers is inclined relative to a radial direction (the direction perpendicular to the tread surface) by an angle equal at most to 45°.

According to another embodiment of the invention, it is possible to only partially reinforce the tread over a portion of its width, preferably the lateral portions close to the axial edges of the tire.

As for short reinforcing fibers that can be used according to the invention the natural or synthetic organic fibers or inorganic fibers known to those skilled in the art and available off the shelf are suitable such as for example the fibers made of cotton, rayon, cellulose, fibers made of aromatic polyamides such as fibers made of armid, such as for example fibers made of Kevlar® sold by Dupont de Nemours, of aliphatic polyamides such as nylon 46 and 66, of polyester, of polyethylene terephthalate (PET), of polyethylene naphthalates (PEN), of polyimides, of polyvinyl alcohols, carbon fibers and glass fibers. According to a preferred embodiment of the invention, the short reinforcing fibers are made of armid. Short metal threads may also be suitable.

The reinforcing fibers may have a length equal to or less than 10 mm, advantageously ranging from 5 μm to 10 mm and preferably ranging from 3 mm to 8 mm, an average diameter ranging from 0.2 μm to 0.1 mm, their section may or may not be circular, they may or may not be hollow. The fiber content in the gum forming each layer of oriented fibers may range from 0.1% to 45% by weight of the rubber, and preferably range from 0.5% to 10% by weight of the rubber.

In the present description, all the percentages (%) are percentages expressed by weight. Moreover, any range of values indicated by the expression “between a and b” represents the range of values greater than the value a and less than the value b (that is to say limits a and b excluded) while any range of values indicated by the expression “from a to b” represents the range of values ranging from the value a up to the value b and including the limits a and b.

The tires comprising a tread according to the invention preferably have a radial carcass reinforcement and are particularly intended to be fitted to the steering axles of heavy goods vehicles intended for usage associated with a regional goods-delivery market. They may also be used for non-steering axles of heavy goods vehicles (tractor and trailer units), for off-road vehicles such as agricultural (forest) machines or construction machines very frequently operating on land comprising many obstacles or foreign bodies to be driven over and subjecting the tires to great shearing forces or other transport or handling vehicles.

In order to prepare the elastomeric layer containing the short reinforcing fibers oriented in one direction at the chosen angle, it is possible to use any method known per se, notably as described for example in patent application WO 2008/027045. Such an elastomeric layer may be used for the manufacture of treads intended for the manufacture of new tires or for the retreading of used tires.

Another subject of the invention is a tire casing comprising a tire tread having the features defined above.

One advantageous embodiment of a tire casing comprising a tread according to the invention consists, by virtue of a liner using a cylinder-based tool, in producing uncured elastomer slabs containing the short reinforcing fibers, and then cutting these slabs and extruding them by means of a micro-nozzle in order to produce elastomer strips in which the short reinforcing fibers are oriented in the direction of the extrusion. The tread is then obtained by superposing on a rotary manufacturing drum several layers, preferably four, of strips that are juxtaposed and then alternately placed at + (plus) or − (minus) 45°; this stack is then cut in the circumferential direction in order to produce a number of section pieces of semi-finished products corresponding to the number (n) of reinforced rib(s) of generally circumferential orientation chosen for the raised element(s) of the tread, which section pieces are placed side by side on the uncured tire itself placed on the tire manufacturing drum.

The variants that have been described above may easily be combined together by those skilled in the art seeking an improvement in performance in resistance to tears due to severe stresses such as those sustained when driving up or driving down kerbs or due to impacts against the kerb or to foreign bodies of a tire notably of a heavy goods vehicle tire with a radial carcass.

Other features and advantages of the invention will emerge from the description made below with reference to the appended drawings which show, as non-limiting examples, several embodiments of the subject of the invention.

FIG. 1 shows two thin layers, each layer comprising fibers oriented either with an angle or with the opposite angle (this stack is marked as follows: layer + and layer −);

FIG. 2 shows a partial view of a sculpture of a tire tread according to the invention for which the whole of the tread is formed by a plurality of thin layers + and −;

FIG. 3 shows a plan view of a tread according to the invention in which only the edge portions are reinforced with thin layers;

FIG. 4 shows a variant of a tread according to the invention in which the blocks are formed of thin layers.

### DESCRIPTION OF THE FIGURES

In order to make the reading of the figures easier, the same references are used to indicate identical structural or functional elements. Moreover, a + sign is placed on a layer reinforced by short fibers oriented at a positive angle and a − sign is placed on a layer reinforced by short fibers oriented at a negative angle.

Shown in FIG. 1 are two successive layers C1, C2 of rubbery material reinforced with short fibers f oriented in each layer at a positive angle A, called layer (+) or at a negative angle B, called layer (−). By orientation of the short fibers in each layer C1, C2, it must of course be understood that on average all or virtually all of the fibers f of a layer are oriented at one and the same average angle A or B, this angle being marked relative to a main direction of the layer (this direction corresponding, once in place in a tread, to the radial direction). According to the manufacturing method chosen for producing such layers, it is possible that a certain number of short reinforcing fibers have an orientation that differs from the average orientation of the said fibers in the layer. The angle of orientation of the fibers is taken relative to a direction which, on the tread, corresponds to a radial direction, that is to say a direction perpendicular to the rotation axis of the tire provided with the said tread.

FIG. 2 shows a variant embodiment of a tire according to the invention. This tire for heavy goods vehicle comprises a tread 1 having a tread surface 10 formed by the surfaces radially on the outside of the various raised elements with which the said tread is provided. In the case shown, the tread is provided with two circumferential grooves 21, these grooves 21 delimiting an intermediate rib 32 and two edge ribs 31, these ribs being circumferentially continuous. The tread is formed in a composite material comprising a very large number of layers C1, C2 stacked one against the other, each layer being either a layer having short reinforcing fibers oriented at an angle A (layer +) or a layer having short fibers oriented at an angle B (layer −). The layers are stacked one against the other so that the short reinforcing fibers of each layer are crossed and so that the stack of layers is made in the circumferential direction (indicated by the arrow T in the figure).

Each layer comprises a rubbery material in which a plurality of short PET fibers with a length equal to 3 mm and a diameter equal to 12 μm are immersed. The fiber density of each layer is 2% by weight. Aramid fiber has also been tested. In the present case, all the short fibers are of the same kind and of the same orientation in absolute value in each layer C1, C2. The grooves of this tire have depths in the new state greater than the average length of the short reinforcing fibers (as a general rule, the depths of the tire grooves for a heavy goods vehicle are at least equal to 10 mm).

FIG. 3 shows a variant of the invention according to which a tread comprises three circumferential grooves delimiting intermediate ribs 32 and edge ribs 31. The latter are situated axially on the edge of the tread and they are formed in a composite material as defined by the invention. Moreover, the layers (+) and the layers (−) are placed so as to make on the tread surface an angle C with a direction tangential to the circumferential direction (indicated by the arrow T in FIG. 2). In the example shown, this angle C is, give or take the sign, the same on both edges and equal to 30°. In this case, the tread acquires a kind of directionality by the arrangement of the layers of materials reinforced by short fibers s. In the example shown, the two intermediate rows between the edge rows are formed in uniform materials not reinforced by short fibers. This variant makes it possible to reinforce specifically the edges of the tread against the assaults to which the tires for heavy goods vehicles may be subjected.

Naturally, those skilled in the art can adapt the angles on each of the edges in order, for example, to take account of the position of the tire on the vehicle (it is thus possible to take account of the outer edge of the tire relative to the vehicle, the inner edge corresponding to the edge of the tire facing the vehicle at the time of installation of the said tire on the said vehicle).

FIG. 4 shows another variant of a tire according to the invention for which its tread comprises a plurality of blocks 4 delimited by circumferential grooves 21 and transverse grooves 22. Each block 4 is formed of a composite material resulting from the stacking in the transverse direction of layers C1, C2 reinforced with short reinforcing fibers, these layers being stacked one against the other, so as to alternate the layers having short fibers oriented at a positive angle (+) and the layers having short fibers oriented at a negative angle (−).

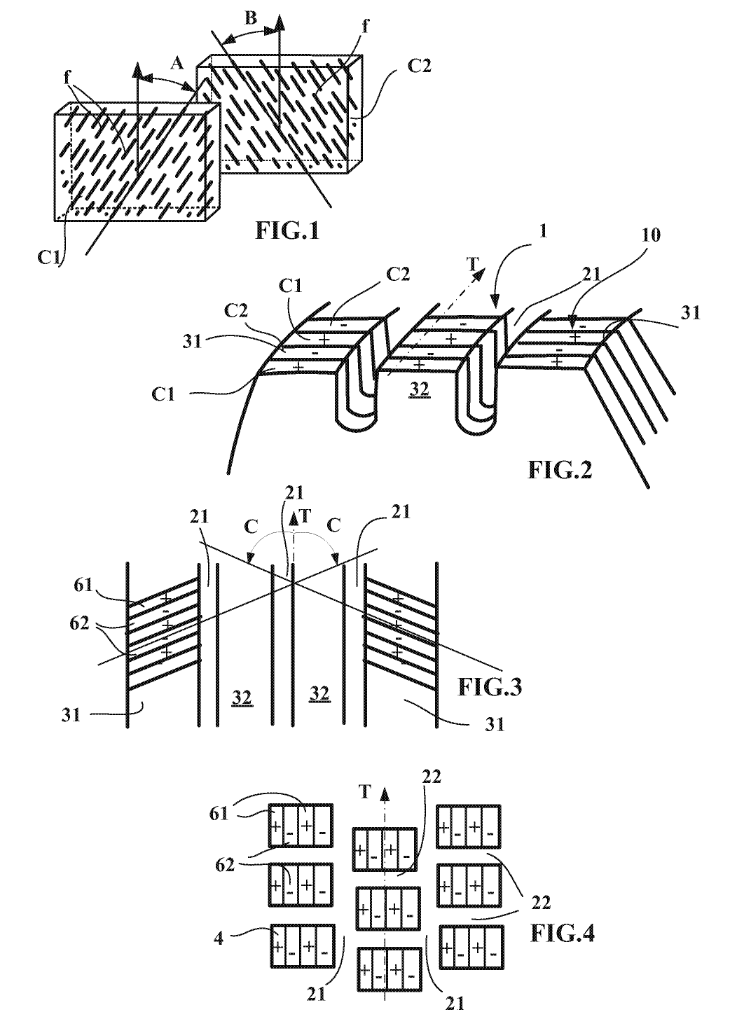

In a variant not shown, certain blocks may be formed by a stacking in the same direction as that shown with FIG. 3 and the others according to a stacking in a direction as shown with FIG. 4.

The examples described here show thin layers placed one against the other in a radial direction, that is to say not inclined relative to a direction perpendicular to the rotation axis of the tire. Naturally the invention encompasses the variants in which these thin layers may have a slight inclination different from zero with a radial direction for generating for example a directional effect.

The invention is not limited to the examples described and shown and various modifications may be made thereto without departing from its context. Its application may also be envisaged in an equivalent manner to the field of tires of the van type or of the passenger-car type having to sustain great stresses that may attack the edges of their treads. An application is equivalent if the length of the short reinforcing fibers chosen is in proportion to the thickness of the tread.

1. A tire tread provided with a tread surface designed to be in contact with a roadway, this tread comprising a sculpture formed by raised elements delimiting at least two grooves of generally circumferential orientation, this tread being formed at least partly in a composite material consisting of a plurality of thin layers of rubber each comprising short reinforcing fibers that are parallel with one another and oriented in one direction in the tread at an angle different from zero degree with a direction contained in the thin layer and perpendicular to the tread surface, this tread being wherein from one layer of rubber to the next the short fibres are crossed.

2. The tread according to claim 1, wherein it comprises a central portion and, on either side, edge portions, and in that only the raised elements of the edge portions are formed of a plurality of thin layers of gum each comprising short reinforcing fibers that are parallel with one another and oriented in one direction in the tread at an angle different from zero degree with a direction contained in the thin layer and perpendicular to the tread surface, and in that from one layer of rubber to the next the short reinforcing fibers are crossed.

3. The tread according to claim 1, wherein it comprises a central portion and on either side edge portions and the raised elements of the central portion and the edge portions of the tread comprise gum reinforced with the aid of the short reinforcing fibers in a plurality of thin crossed layers, the angles of the short reinforcing fibers in the central portion being different from the angles of the short reinforcing fibers in the edge portions.

4. The tread according to claim 1, wherein the short reinforcing fibers are crossed from one layer to the other at an angle that is symmetrical relative to a radial direction.

5. The tread according to claim 1, wherein the short reinforcing fibers are crossed from one layer to the other at an angle equal to or close to +45° and −45°.

6. The tread according to claim 1, wherein the short reinforcing fibers are crossed from one layer to the other in a manner that is dissymmetrical relative to a radial direction.

7. The tread according to claim 1, wherein the short reinforcing fibers are chosen from the plant fibers, cotton, rayon, cellulose, fibers made of aromatic polyamides such as fibers made of aramid, of aliphatic polyamides, of polyester, of polyethylene terephthalate (PET), of polyethylene naphthalates (PEN), of polyimides, of polyvinyl alcohols, carbon fibers and glass fibers.

8. The tread according to claim 1, wherein the short reinforcing fibers have a length at most equal to 10 mm.

9. The tread according to claim 1, wherein the short reinforcing fibers have a length at least equal to 3 mm and at most to 8 mm.

10. The tread according to claim 8, wherein the short reinforcing fibers have an average sectional diameter ranging from 0.2 micron to 0.1 mm.

11. The tread according to claim 1, wherein the content of short reinforcing fibers in each layer is at least equal to 0.1% and at most to 45% by weight of the rubber of the said layer.

12. A tire for heavy goods vehicle with radial carcass reinforcement, comprising a tread defined according to claim 1.

13. The tread according to claim 1, wherein the aliphatic polyamide is nylon 46 or nylon 66.
